(19) United States
(12) Patent Application Publication
(10) Pub. No.: US 2009/0243981 A1
(43) Pub. Date: Oct. 1, 2009

(54) Driving module of display device and method for extending lifetime of the driving module

(76) Inventors: Yung-Chih Chen, Hsin-Chu (TW); Chun-Hsin Liu, Hsin-Chu (TW); Po-Yuan Liu, Hsin-Chu (TW); Min-Feng Chiang, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 12/185,821

(22) Filed: Aug. 5, 2008

(30) Foreign Application Priority Data
Mar. 26, 2008 (TW) 097110744

(51) Int. Cl. G09G 3/36

(52) U.S. Cl. 345/87

(57) ABSTRACT

A driving module drives a display device having a plurality of pixel switches. The driving module includes a gate driving circuit, a plurality of switch components, and a shorting line. The gate driving circuit includes a plurality of output ends correspondingly coupled to the plurality of the pixel switches through a plurality of gate lines for outputting a plurality of gate driving signals and turning on the plurality of the pixel switches. The plurality of the gate lines are coupled to the shorting line through the switch components. Each control end of the switch components is coupled to the gate driving circuit for receiving the gate driving signals in order to refresh the state of the switch components.

### BACKGROUND OF THE INVENTION

1. Field of the Invention

The present invention relates to a driving module, and more particularly, to a driving module of a liquid crystal display (LCD) device and a method for extending the lifetime of the driving module.

2. Description of the Prior Art

Please refer to FIG. 1. It is a diagram illustrating a conventional LCD device 100 during fabricating process. The pixel area 110 comprises a plurality of gate lines GL₁˜GL_{N}, a plurality of data lines DL₁˜DL_{M}, and a plurality of pixel switches SW_{P} interwoven by the gate lines and the data lines. Each pixel switch SW_{P} of the pixel area 110 comprises a first end 1 coupled to a corresponding data line, a second end 2 coupled to a storage capacitor C_{S} of a corresponding pixel, and a control end C coupled to a corresponding gate line. For example, the first end 1 of the pixel switch SW_{P11} is coupled to the data line DL₁, the second end 2 of the pixel switch SW_{P11} is coupled to the storage capacitor C_{S11}, and the control end C of the pixel switch SW_{P11} is coupled to the gate line GL₁. As shown in FIG. 1, during the fabricating process, the gate lines corresponding to the pixel switches SW_{P} of the pixel area 110 of the LCD device 100 are short-circuited to two shorting lines GSL₁ and GSL₂, the data lines corresponding to the pixel switches SW_{P} of the pixel area 110 of the LCD device 100 are short-circuited to three shorting lines DSL₁, DSL₂, and DSL₃. Test signals are respectively transmitted into the pads GO, GE, R, G, and B for testing the operation of the pixel area 110. After the testing procedure is done, the following laser cut procedure is executed (as the dash line shown in FIG. 1) for cutting the connections between the shorting lines, the gate lines, and the data lines. After the laser cut procedure is done, the gate driving circuit 120 and the data driving circuit 130 are respectively coupled to the corresponding pads P_{G} and P_{D}. In this way, the LCD device 100 is completely fabricated.

However, in the conventional fabricating process, the laser cut procedure is necessary for disconnecting the short-circuited parts, which increases expense of the fabrication.

### SUMMARY OF THE INVENTION

To solve the aforementioned problems, the present invention provides a driving module for driving a display device. The display device has a plurality of gate lines, a plurality of data lines, a plurality of pixel switches interwoven by the plurality of gate lines and the plurality of data lines. A control end of each pixel switch is coupled to the corresponding gate line, a first end of each pixel switch is coupled to the corresponding data line. The driving module comprises a gate driving circuit and a plurality of gate shorting switches. The gate driving circuit comprises a plurality of first output ends for sequentially outputting a plurality of first gate driving signals to turn on the plurality of pixel switches of the display device, and at least one second output end for outputting a second gate driving signal after the plurality of the first gate driving signals are outputted. Each gate shorting switch comprises a first end, a second end, and a control end. The control ends of the plurality of the gate shorting switches are coupled to the at least one second output end of the gate driving circuit for receiving the second gate driving signal to control states of the plurality of gate shorting switches.

The present invention further provides a display device. The display device comprises a pixel area, and a driving module. The pixel area comprises a plurality of gate lines, a plurality of data lines, and a plurality of pixel switches interwoven by the plurality of gate lines and the plurality of data lines. Each pixel switch comprises a control end coupled to a corresponding gate line, and a first end coupled to a corresponding data line. The driving module comprises a gate driving circuit and a plurality of gate shorting switches. The gate driving circuit comprises a plurality of first output ends for outputting a plurality of first gate driving signals to turn on the plurality of pixel switches of the display device, and at least one second output end for outputting at least one second gate driving signal. Each first output end of the gate driving circuit is coupled to a corresponding gate line of pixel area. Each gate shorting switch comprises a first end, a second end, and a control end coupled to the at least one second output end of the gate driving circuit for receiving the at least one second gate driving signal to control state of the gate shorting switch.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional LCD device during fabricating process.

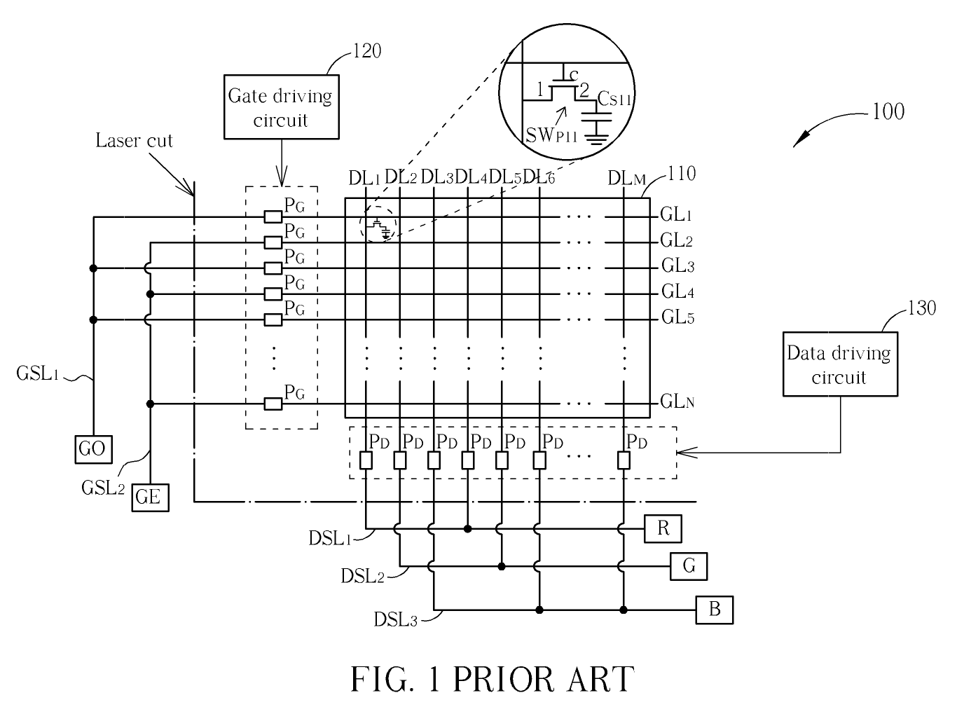

FIG. 2 is a diagram illustrating an LCD device of the present invention during the fabricating process.

FIG. 3 is a diagram illustrating the LCD device after the fabricating process.

FIG. 4 is a timing diagram illustrating the gate driving signals when the LCD device displays frames.

FIG. 5 is a diagram illustrating the gate driving circuit of the present invention.

FIG. 6 is a timing diagram illustrating the gate driving signals when the LCD device displays frames.

FIG. 7 is a flowchart illustrating the steps of the method of the present invention for extending lifetime of driving module of an LCD device.

### DETAILED DESCRIPTION

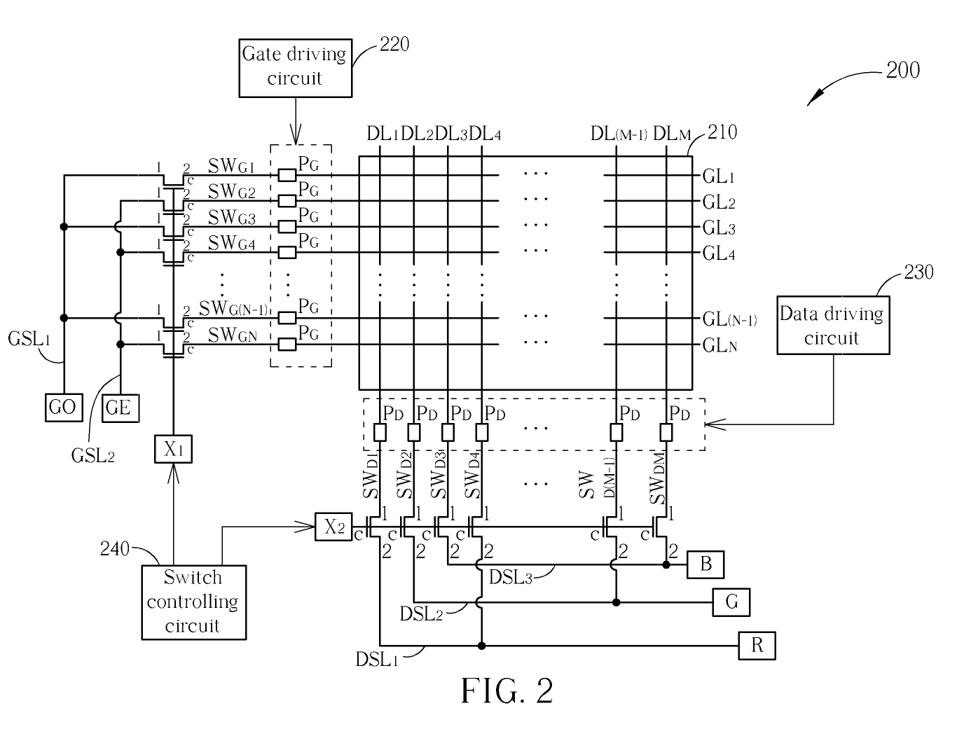

Please refer to FIG. 2. It is a diagram illustrating an LCD device 200 of the present invention during the fabricating process. The difference between the conventional LCD device 100 and the LCD device 200 of the present invention during the fabricating process is that, in the LCD device 200, shorting switches SW_{G1}˜SW_{GN}, and SW_{D1}˜SW_{DM} are further disposed between the shorting lines GSL₁, and GSL₂, and the pads P_{G}, and are disposed between the shorting lines DSL₁, DSL₂, and DSL₃, and the pads P_{D} respectively. As shown in FIG. 2, during the fabricating process, in the LCD device 200, the gate lines GL₁˜GL_{N} of the pixel area 210 are coupled to the shorting lines GSL₁ and GSL₂ through the pads P_{G} and the gate shorting switches SW_{G1}˜SW_{GN} respectively, and the data lines DL₁˜DL_{N} are coupled to the shorting lines DSL₁, DSL₂, and DSL₃ through the pads P_{D} and the data shorting switches SW_{D1}˜SW_{DM} respectively. Each of the gate/data shorting switches SW_{G1}˜SW_{GN} and SW_{D1}˜SW_{DM} comprises a first end 1, a second end 2, and a control end C. For example, the first end 1 of the gate shorting switch SW_{G1} is coupled to the gate line GL₁ through a pad P_{G}, the second end 2 of the gate shorting switch SW_{G1} is coupled to the shorting line GSL₁, and the control end C of the gate shorting switch SW_{G1} is coupled to the pad X₁; the first end 1 of the gate shorting switch SW_{G2} is coupled to the gate line GL₂ through a pad P_{G}, the second end 2 of the gate shorting switch SW_{G2} is coupled to the shorting line GSL₂, and the control end C of the gate shorting switch SW_{G2} is coupled to the pad X₁ . . . and so on. The first end 1 of the data shorting switch SW_{D1} is coupled to the data line DL₁ through a pad P_{D}, the second end 2 of the data shorting switch SW_{D1} is coupled to the shorting line DSL₁, and the control end C of the data shorting switch SW_{D1} is coupled to the pad X₂; the first end 1 of the data shorting switch SW_{D2} is coupled to the data line DL₂ through a pad P_{D}, the second end 2 of the data shorting switch SW_{D2} is coupled to the shorting line DSL₂, and the control end C of the data shorting switch SW_{D2} is coupled to the pad X₂ . . . and so on. During the testing procedure, all the shorting switches SW_{G1}˜SW_{GN} and SW_{D1}˜SW_{DN} are turned on by the controlling signals transmitted from the pads X₁ and X₂, namely, the test signals are transmitted to the gate lines GL₁˜GL_{N} through the pads GO and GE, and to the data lines DL₁˜DL_{M} through the pads R, G, and B. After the testing procedure is done, the gate driving circuit 220, the data driving circuit 230, and the switch controlling circuit 240 are coupled to the corresponding pads P_{G}, P_{D}, X₁, and X₂ (for example, the driving circuits may be ICs bonded on the LCD device) respectively and consequently the fabrication of the LCD device 200 is completed. The switch controlling circuit 240 controls the gate shorting switches SW_{G1}˜SW_{GN} and data shorting switches SW_{D1}˜SW_{DM} to be turned off for avoiding interfering with the regular operation of the LCD device 200. Thus, it is unlike the conventional art, the laser cut procedure can be omitted in the present invention.

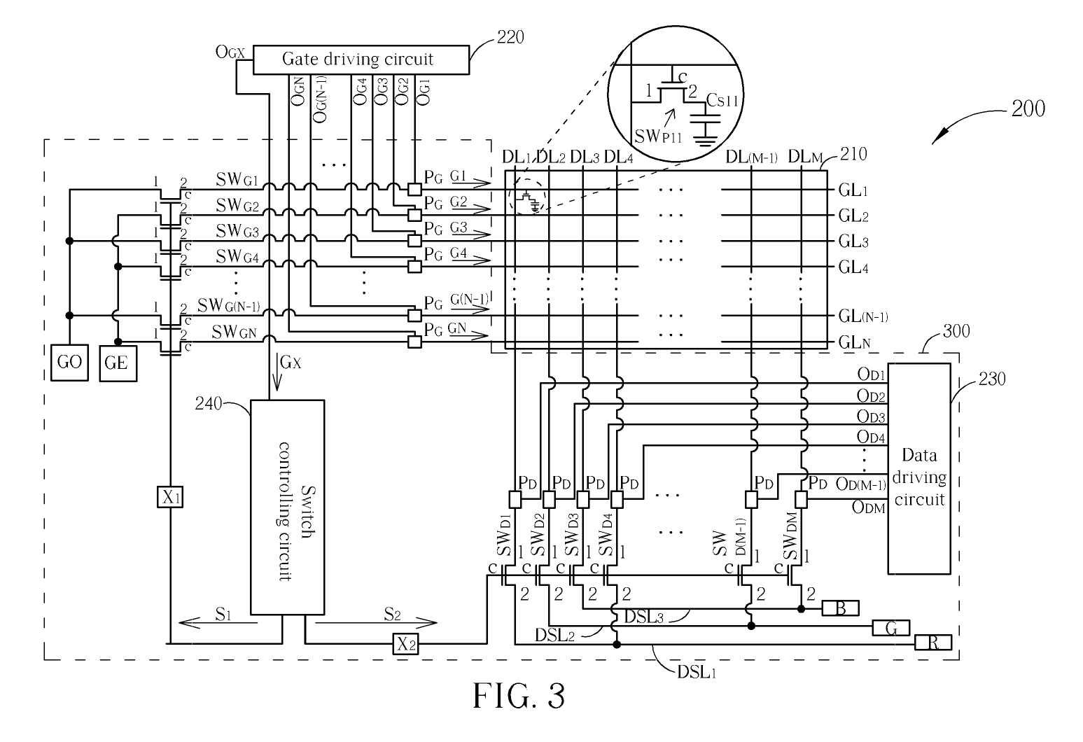

Please refer to FIG. 3. It is a diagram illustrating the LCD device 200 after the fabricating process. As shown in FIG. 3, the LCD device 200 comprises a pixel area 210, and a driving module 300. After the testing procedure is done, the gate driving circuit 220, the data driving circuit 230, and the switch controlling circuit 240 are further installed onto the LCD device 200. The driving module 300 comprises the gate driving circuit 220, the data driving circuit 230, the switch controlling circuit 240, the gate shorting switches SW_{G1}˜SW_{GN}, and the data shorting switches SW_{D1}˜SW_{DM}. The gate driving circuit 220 comprises N first output ends O_{G1}˜O_{GN} for sequentially outputting gate driving signals G₁˜G_{N} and at least one second output end O_{GX} for outputting a gate driving signal G_{X}. The first output ends O_{G1}˜O_{GN} of the gate driving circuit 220 coupled to the corresponding gate lines GL₁˜GL_{N} through the pads P_{G} output gate driving signals G₁˜G_{N} sequentially to the pixel area 210. More particularly, the control end C of the pixel switch SW_{P} of the pixel area 210 receives a corresponding gate driving signal through the corresponding gate line, and when the control end C of a pixel switch SW_{P} of the pixel area 210 receives a corresponding gate driving signal, the first end 1 of the pixel switch SW_{P} is coupled to the second end 2 of the pixel switch SW_{P}. For example, as shown in FIG. 3, when the control end C of the pixel switch SW_{P11} receives the gate driving signal G₁, the first end 1 of the pixel switch SW_{P11} is coupled to the second end of the pixel switch SW_{P11} so that the data driving signal on the data line DL₁ can be transmitted to the capacitor C_{S11} of the pixel through the pixel switch SW_{P11}. The data driving circuit 230 comprises M output ends O_{D1}˜O_{DM} for outputting data signals. The output ends O_{D1}˜O_{DM} of the data driving circuit 230 coupled to the corresponding data lines DL₁˜DL_{M} through the pads P_{D} output data signals to the pixel area 210. Each of the gate shorting switches SW_{G1}˜SW_{GN}, and the data shorting switches SW_{D1}˜SW_{DM} comprises a first end 1, a second end 2, and a control end C as the same as the description for FIG. 2. Each of the gate shorting switches SW_{G1}˜SW_{GN}, and the data shorting switches SW_{D1}˜SW_{DM} is coupled to the shorting lines GSL₁, GSL₂, DSL₁, DSL₂, and DSL₃, the switch controlling circuit 240, the gate driving circuit 220 through the pads P_{G}, and the data driving circuit 230 through the pads P_{D}, respectively.

The switch controlling circuit 240 controls the shorting switches SW_{G1}˜SW_{GN}, and SW_{D1}˜SW_{DM} to be turned “on” or turned “off”. More particularly, the switch controlling circuit 240 controls the shorting switches SW_{G1}˜SW_{GN}, and SW_{D1}˜SW_{DM} to be turned off for avoiding interfering with the operation of the LCD device 200 when the control end C of a pixel switch SW_{P} of the pixel area 210 receives a corresponding gate driving signal. The switch controlling circuit 240 coupled to the second output end OG_{X} of the gate driving circuit 220 outputs the switch controlling signals S₁ and S₂ respectively to control the gate shorting switches SW_{G1}˜SW_{GN}, and the data shorting switches SW_{D1}˜SW_{DM} according to the gate driving signal G_{X} received from the gate driving circuit 220. For example, when the switch controlling circuit 240 outputs the switch controlling signals S₁ and S₂ of logic “0” (low voltage level), the shorting switches SW_{G1}˜SW_{GN}, and SW_{D1}˜SW_{DM} are all turned off. However, if all the shorting switches SW_{G1}˜SW_{GN}, and SW_{D1}˜SW_{DM} are kept at the “off” state permanently, the lifetimes of the shorting switches SW_{G1}˜SW_{GN}, and SW_{D1}˜SW_{DM} will be shortened and it will lead to unwanted characteristics, e.g. current leakage. More particularly, because the laser cut procedure is omitted, the shorting switches SW_{G1}˜SW_{GN}, and SW_{D1}˜SW_{DM} are required to be turned off during the regular operation. In order to extend the lifetimes of the shorting switches, the present invention, on an appropriate occasion, refreshes the on/off states of the shorting switches SW_{G1}˜SW_{GN}, and SW_{D1}˜SW_{DM}. That is, the shorting switches SW_{G1}˜SW_{GN}, and SW_{D1}˜SW_{DM} can be turned on by changing the voltage of the switch controlling signals to refresh the states of the shorting switches SW_{G1}˜SW_{GN}, and SW_{D1}˜SW_{DM} at a suitable time during the operation of the LCD device of the present invention for extending the lifetimes of the gate/data shorting switches.

Alternatively, in another modified embodiment, the switch controlling circuit 240 is simplified to be at least one wire coupling the control ends C of the shorting switches SW_{G1}˜SW_{GN}, and SW_{D1}˜SW_{DM} to the output ends of the gate driving circuit 220, respectively. However, the output ends of the gate driving circuit 220, coupled to the control ends of the shorting switches SW_{G1}˜SW_{GN}, and SW_{D1}˜SW_{DM}, have to be different from those output ends O_{G1}˜O_{GN} of the gate driving circuit 220 coupled to the gate lines GL₁˜GL_{N} of the pixel area 210 for outputting the gate driving signals G₁˜G_{N}. The shorting switches SW_{G1}˜SW_{GN} and SW_{D1}˜SW_{DM} can be turned on for refreshing by the selected gate driving signals. For example, the gate driving circuit 220 can comprises (N+1) output ends O_{G1}˜O_{GN} (first output ends), and O_{G(N+1)} (second output end OG_{X}) for sequentially transmitting gate driving signals G₁˜G_{N}, and G_{(N+1)}. The output ends O_{G1}˜O_{GN} of the gate driving circuit 220 are coupled to the gate lines GL₁˜GL_{N}, respectively. Therefore, the output end O_{G(N+1)} of the gate driving circuit 220 for outputting the gate driving signal G_{(N+1)} can be utilized as the switch controlling signals S₁ and S₂. That is, the switch controlling circuit 240 is simplified to be one wire coupling the control ends C of the shorting switches SW_{G1}˜SW_{GN}, and SW_{D1}˜SW_{DM} to the output end O_{G(N+1)} (OG_{X}) of the gate driving circuit 220.

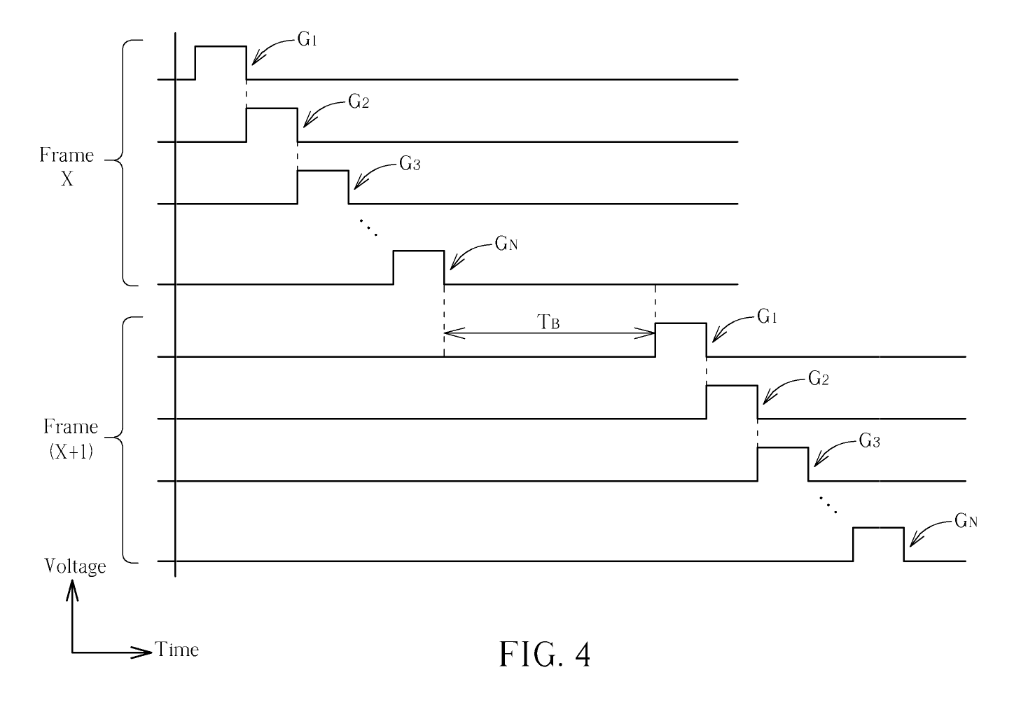

Please refer to FIG. 4. It is a timing diagram illustrating the gate driving signals while the LCD device displays frames. As shown in FIG. 4, while the frame X is displayed, the gate driving signals G₁˜G_{N} are transmitted to the corresponding gate lines, as the switch controlling signals S₁ and S₂ are logic “0” for turning off the shorting switches SW_{G1}˜SW_{GN}, and SW_{D1}˜SW_{DM}. Similarly, while the frame (X+1) is displayed, the gate driving signals G₁˜G_{N} are again transmitted to the corresponding gate lines as well, as the switch controlling signals S₁ and S₂ are logic “0” for turning off the shorting switches SW_{G1}˜SW_{GN}, and SW_{D1}˜SW_{DM}. During the period T_{B}, which is between the frames X and (X+1) and is so-called the blanking period, there are no gate driving signals transmitted to the gate lines of the pixel area 210. The present invention utilizes the period T_{B} for refreshing the state of the shorting switches SW_{G1}˜SW_{GN}, and SW_{D1}˜SW_{DM}. More particularly, the switch controlling circuit 240 outputs the switch controlling signals S₁ and S₂ of logic “1” (high voltage level) for turning on the shorting switches SW_{G1}˜SW_{GN}, and SW_{D1}˜SW_{DM} during the period T_{B} for refreshing. Since during the period T_{B}, there are no gate driving signals that would be transmitted to the gate lines of the pixel area 210, it will not affect the regular operation for the pixel area 210.

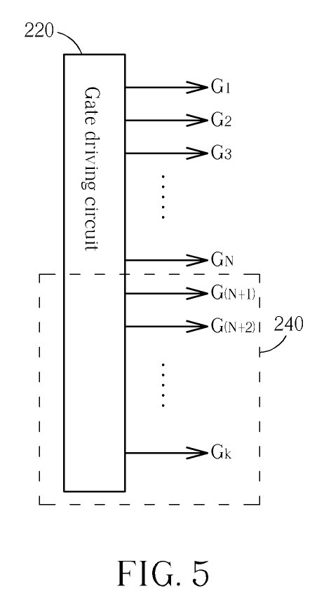

Please refer to FIG. 5. It is a diagram illustrating the gate driving circuit 220 of the present invention. Generally, the number of the gate driving signals of the gate driving circuit 220 (namely, the number of the output pin) are more than the number of the gate lines of the pixel area 210. In other words, the amount of the gate driving signals generated from the gate driving circuit 220 is more than the gate lines of the pixel area 210 required. For example, the number of the gate lines of the pixel area 210 is designed to be N, and the number of the gate driving signals of the gate driving circuit 220 is designed to be K, which is greater than N. Therefore, the gate driving circuit 220 can sequentially outputs gate driving signals G₁˜G_{K}. The switch controlling circuit 240 can be realized by utilizing the gate driving signals G_{(N+1)}˜G_{K}. More particularly, any gate driving signal from the gate driving signals G_{(N+1)}˜G_{K} can be appropriately selected to be the switch controlling signals S₁ and S₂. For example, the switch controlling signal S₁ can be utilized with the gate driving signal G_{(N+1)}, and the switch controlling signal S₂ can be utilized with the gate driving signal G_{(N+2)}, or, both of the switch controlling signals S₁ and S₂ can be utilized with the same gate driving signal G_{(N+1)}.

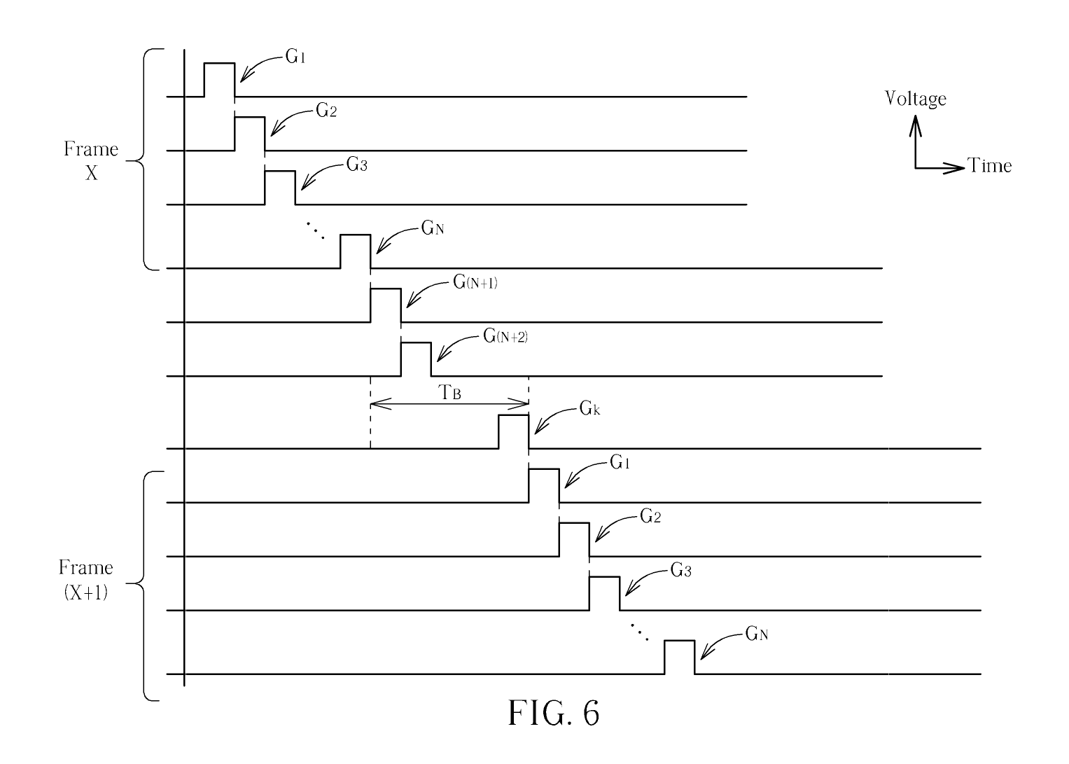

Please refer to FIG. 6. It is a timing diagram illustrating the gate driving signals when the LCD device displays frames. As shown in FIG. 6, a period T_{B} exists between the frames X and (X+1). During the period T_{B}, the gate driving circuit 220 outputs gate driving signals G_{(N+1)}˜G_{K}, nevertheless, there are no gate driving signals that would be transmitted to the gate lines of the pixel area 210. The present invention utilizes at least one of the gate driving signals G_{(N+1)}˜G_{K} during this period T_{B} to refresh the state of the shorting switches SW_{G1}˜SW_{GN}, and SW_{D1}˜SW_{DM}. More particularly, the switch controlling circuit 240 can utilize any of the gate driving signals G_{(N+1)}˜G_{K} as the switch controlling signals S₁ and S₂ for turning on the shorting switches SW_{G1}˜SW_{GN}, and SW_{D1}˜SW_{DM} (or only changing the voltage on the control ends of the shorting switches SW_{G1}˜SW_{GN}, and SW_{D1}˜SW_{DM}) during the period T_{B}. That is, the switch controlling circuit 240 is simplified to be at least one wire coupling to the output ends which transmit the gate driving signals G_{(N+1)}˜G_{K} respectively.

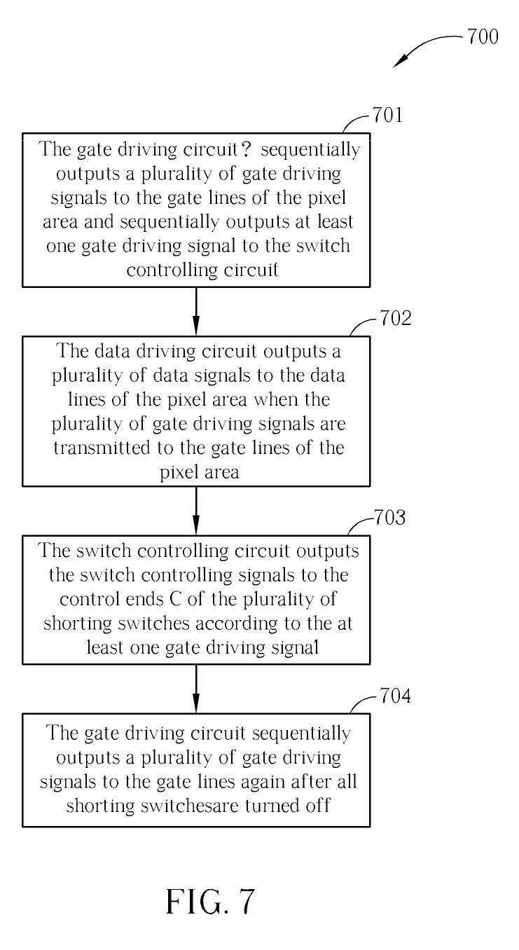

Please refer to FIG. 7. It is a flowchart illustrating the steps of the method 700 of the present invention for extending lifetime of driving module 300 of the LCD device 200. The steps of the method 700 are described as follows:
Step 701: The gate driving circuit 220 sequentially outputs a plurality of gate driving signals G₁˜G_{N} to the gate lines GL₁˜GL_{N} of the pixel area 210 and sequentially outputs at least one gate driving signal G_{X} to the switch controlling circuit 240;
Step 702: The data driving circuit 230 outputs a plurality of data signals to the data lines DL₁˜DL_{M} of the pixel area 210 when the plurality of gate driving signals G₁˜G_{N} are transmitted to the gate lines GL₁˜GL_{N} of the pixel area 210;
Step 703: The switch controlling circuit 240 outputs the switch controlling signals S₁ and/or S₂ to the control ends C of the plurality of shorting switches SW_{G1}˜SW_{GN}, and/or SW_{D1}˜SW_{DM} according to the at least one gate driving signal G_{X} thereby refreshing them while there is no gate driving signal transmitted to the gate lines GL₁˜GL_{N} of the pixel area 210;
Step 704: The gate driving circuit 220 sequentially outputs a plurality of gate driving signals G₁˜G_{N} to the gate lines GL₁˜GL_{N} again after all shorting switches SW_{G1}˜SW_{GN}, and/or SW_{D1}˜SW_{DM} are turned off.
   In step 701, the gate driving signal G_{X} can be at least one of the gate driving signals G_{(N+1)}˜G_{K} as disclosed in FIG. 5. That is, the at least one gate driving signal G_{X} can be only the gate driving signal G_{(N+1)}, or can be comprised with two of the gate driving signals G_{(N+1)} and G_{(N+2)}. In step 703, the switch controlling signals S₁ and S₂ are outputted according to the at least one gate driving signal G_{X}. Therefore, when the gate driving signal G_{X} is only the gate driving signal G_{(N+1)}, the switch controlling signal S₁ and S₂ are both the same as the gate driving signal G_{(N+1)}, and when the at least one gate driving signal G_{X} comprises two gate driving signals G_{(N+1)} and G_{(N+2)}, the switch controlling signals S₁ and S₂ can be the same as the gate driving signals G_{(N+1)} and G_{(N+2)}, respectively.

To sum up, the driving module of the LCD device of the present invention utilizes the blanking period between one frame and another frame for refreshing the states of the shorting switches. In this way, the lifetimes of the shorting switches can be extended and consequently the lifetime of the LCD device is extended as well, which increases convenience.

Those skilled in the art will readily observe that numerous modifications and alterations of the device and method may be made while retaining the teachings of the invention.

What is claimed is:

1. A driving module for driving a display device, the display device having a plurality of gate lines, a plurality of data lines, a plurality of pixel switches interwoven by the plurality of gate lines and the plurality of data lines, a control end of each pixel switch being coupled to the corresponding gate line, a first end of each pixel switch being coupled to the corresponding data line, the driving module comprising:
a gate driving circuit, comprising:
a plurality of first output ends for sequentially outputting a plurality of first gate driving signals to turn on the plurality of pixel switches of the display device; and
at least one second output end for outputting a second gate driving signal after the plurality of the first gate driving signals are outputted; and
a plurality of gate shorting switches, each gate shorting switch comprising a first end, a second end, and a control end, the control ends of the plurality of the gate shorting switches being coupled to the at least one second output end of the gate driving circuit for receiving the second gate driving signal to control states of the plurality of gate shorting switches.

2. The driving module of claim 1, further comprising a switch controlling circuit coupled between the at least one second output end of the gate driving circuit and the control ends of the plurality of the gate shorting switches.

3. The driving module of claim 1, further comprising a gate shorting line, wherein the second ends of at least two gate shorting switches are coupled to the gate shorting line.

4. The driving module of claim 3, wherein each first end of the gate shorting switches is coupled to a corresponding gate line.

5. The driving module of claim 1, further comprising a plurality of data shorting switches, each data shorting switch comprising a first end, a second end and a control end, the control ends of the plurality of the data shorting switches being coupled to the at least one second output end of the gate driving circuit for receiving the second gate driving signal to control states of the plurality of data shorting switches.

6. The driving module of claim 5, further comprising a switch controlling circuit coupled between the at least one second output end of the gate driving circuit and control ends of the data shorting switches.

7. The driving module of claim 5, further comprising a data shorting line, wherein the second ends of at least two data shorting switches are coupled to the data shorting line.

8. The driving module of claim 7, wherein each first end of the data shorting switches is coupled to a corresponding data line.

9. A method for extending lifetime of a driving module of a display device, the display device comprising a pixel area, and a driving module of claim 8, the method comprising:
sequentially transmitting a plurality of first gate driving signals to the pixel area for turning on the plurality of the pixel switches and transmitting at least one second gate driving signal to the switch controlling circuit;
transmitting a plurality of data signals to the pixel area when the plurality of the first gate driving signal are transmitted to the pixel area for turning on the plurality of the pixel switches; and
transmitting a switch controlling signal by the switch controlling circuit to turn on each of the shorting switches according to the at least one second gate driving signal.

10. The method of claim 9, wherein the switch controlling signal is the same as the at least one second gate driving signal.

11. The method of claim 9, wherein the at least one second gate driving signal is transmitted when any of first gate driving signals is not transmitted to the plurality of the pixel area.

12. A display device, comprising:
a pixel area, comprising:
a plurality of gate lines;
a plurality of data lines; and
a plurality of pixel switches interwoven by the plurality of gate lines and the plurality of data lines, each pixel switch comprising:
a control end coupled to a corresponding gate line; and
a first end coupled to a corresponding data line; and
a driving module, comprising:
a gate driving circuit, comprising a plurality of first output ends for outputting a plurality of first gate driving signals to turn on the plurality of pixel switches of the display device and at least one second output end for outputting at least one second gate driving signal, each first output end of the gate driving circuit being coupled to a corresponding gate line of pixel area; and
a plurality of gate shorting switches, each gate shorting switch comprising:
a first end;
a second end; and
a control end coupled to the at least one second output end of the gate driving circuit for receiving the at least one second gate driving signal to control state of the gate shorting switch.

13. The display device of claim 12, further comprising a switch controlling circuit coupled between the second output end of the gate driving circuit and the control ends of the plurality of the gate shorting switches.

14. The display device of claim 12, further comprising a gate shorting line, the second ends of at least two gate shorting switches being coupled to the gate shorting line.

15. The display device of claim 14, wherein each first end of the gate shorting switches is coupled to a corresponding gate line.

16. The display device of claim 12, further comprising a plurality of data shorting switches, each data shorting switch comprising a first end, a second end and a control end, the control ends of the plurality of the data shorting switches being coupled to the at least one second output end of the gate driving circuit for receiving the at least one second gate driving signal to control states of the plurality of data shorting switches.

17. The display device of claim 16, further comprising a switch controlling circuit coupled between the second output end of the gate driving circuit and control ends of the data shorting switches.

18. The display device of claim 16, further comprising a data shorting line, the second ends of at least two data shorting switches being coupled to the data shorting line.

19. The display device of claim 18, wherein each first end of the data shorting switches is coupled to a corresponding data line.
